(19) United States
(12) Patent Application Publication
(10) Pub. No.: US 2025/0222440 A1
(43) Pub. Date: Jul. 10, 2025

(54) LOW Z/M FCC CATALYSTS MADE BY IN-SITU CRYSTALLIZATION OF PURE ALUMINA PARTICLES

(71) Applicant: BASF Corporation, Florham Park, NJ (US)

(72) Inventors: Karl C. KHARAS, Dublin, OH (US); Dana Rehms MOONEY, Vidalia, LA (US); Peter NAGEL, Iselin, NJ (US)

(21) Appl. No.: 18/701,874

(22) PCT Filed: Oct. 20, 2022
(86) PCT No.: PCT/US2022/047313

§ 371 Date: Apr. 16, 2024

Related U.S. Application Data
(60) Provisional application No. 63/270,462, filed on Oct. 21, 2021.

(51) Int. Cl. B01J 29/08; B01J 35/40; B01J 37/00; C10G 11/05

(52) U.S. Cl. CPC B01J 29/088; B01J 35/40; B01J 37/0036; B01J 37/0045; C10G 11/05; B01J 2235/15

(57) ABSTRACT

Disclosed herein is a fluid catalyst cracking (FCC) catalyst component including an in-situ crystallized zeolite on pure alumina particles, wherein the FCC catalyst component has a ratio of zeolite surface area (ZSA) to matrix surface area (MSA) of less than about 1.3. Also disclosed herein FCC catalyst compositions that include said FCC catalyst components, methods of preparing the FCC catalyst composition, methods of preparing the FCC catalyst component, and methods of using the FCC catalyst composition or the FCC catalyst component.

### CROSS-REFERENCE TO RELATED APPLICATION(S)

This application claims the benefit of priority of U.S. Provisional Patent Application No. 63/270,462, filed on Oct. 21, 2021, the disclosure of which is hereby incorporated by reference herein in its entirety.

### FIELD OF THE DISCLOSURE

The present disclosure relates to petroleum refining catalysts and compositions thereof. In particular, the present disclosure relates to fluid catalytic cracking (FCC) catalysts and compositions thereof, methods of their preparation, and methods of their use.

### BACKGROUND OF THE DISCLOSURE

Certain FCC markets are experiencing a shift to value light cycle oil (LCO), which is a diesel fuel precursor, and liquefied petroleum gas (LPG, e.g., LPG olefins) more than FCC gasoline.

FCC catalyst components can address this trend through design to reduce the zeolite surface area to matrix surface area (Z/M). Existing low Z/M FCC catalysts include non-zeolitic matrix materials other than alumina, such as clay. It is believed, without being construed as limiting, that FCC catalyst components with non-zeolitic matrix materials other than alumina, such as clay, sometimes exhibit a higher coke yield, as compared to the coke yield exhibited by FCC catalyst components having an alumina matrix material.

There remains a need to develop FCC catalyst components exhibiting improved LCO and LPG yields while minimizing coke formation.

### SUMMARY OF THE DISCLOSURE

The present disclosure provides a fluid catalytic cracking (FCC) catalyst component that includes an in-situ crystallized zeolite on pure alumina particles, wherein the FCC catalyst component has a ratio of zeolite surface area (ZSA) to matrix surface area (MSA) of less than about 1.3.

Various zeolites may be crystallized on the pure alumina particles, such as, without limitation, zeolites with the structure BEA, MSE, -SVR, FAU, MOR, CON, SOF, MFI, IMF, FER, MWW, MTT, TON, EUO, MRE, NAT, CHA, EMT, or a mixture of two or more thereof. In certain embodiments, the zeolite may be selected from zeolite X, Y-zeolite, ZSM-5, beta zeolite, ZSM-11, ZSM-14, ZSM-17, ZSM-18, ZSM-20, ZSM-31, ZSM-34, ZSM-41, ZSM-46, mordenite, chabazite, or mixtures of two or more thereof. In one embodiment, the zeolite is zeolite Y. In certain embodiments, e.g., when the zeolite is zeolite Y, the zeolite may have a unit cell size of about 24.20 Å to about 24.70 Å.

The pure alumina particles may include one or more of alumina derived from boehmite, alumina derived from pseudo boehmite, alumina derived from flash calcined gibbsite, boehmite, pseudo boehmite, flash calcined gibbsite, calcined flash calcined gibbsite, silica-doped alumina, gamma-alumina, χ-alumina, δ-alumina, θ-alumina, κ-alumina, α-alumina, rare earth-modified variations thereof, alkaline earth metal-modified variations thereof, bismuth-modified variations thereof, or a mixture of two or more thereof.

In one embodiment, the pure alumina particles may be made by first milling an alumina precursor (e.g., dry milling such as, without limitations, chop milling, hammer milling, or ball milling, or wet milling), slurrying the milled alumina precursor, and spray drying the milled and slurried alumina precursors to make alumina particles having a suitable average particle size. In an alternative embodiment, the pure alumina particles may have a suitable average particle size without being milled. Suitable particle size for the pure alumina particles, whether milled or unmilled, may range from about 40 μm to about 150 μm, about 60 μm to about 120 μm, or about 80 μm to about 100 μm.

In certain embodiments, the pure alumina particles and/or the zeolite may be modified by a non-alumina constituent selected from a rare earth element, bismuth, an alkaline earth element, or a mixture of two or more thereof. Suitable rare earth elements may include ytterbium, gadolinium, cerium, lanthanum, or a mixture of two or more thereof. Suitable alkaline earth elements may include barium, strontium, calcium, magnesium, or a mixture of two or more thereof.

In certain embodiments, the present disclosure provides a method for preparing any of the FCC catalyst components described herein. The method includes crystallizing, in-situ, a zeolite on pure alumina particles, wherein the FCC catalyst component has a ratio of ZSA to MSA of less than about 1.3. The zeolite may be any of the zeolites described herein. The pure alumina particles may be any of the pure alumina particles described herein.

In certain embodiments, crystallizing includes mixing pure alumina particles with an aluminum source, a silicon source, optionally sodium hydroxide, and water to form an alkaline slurry. In certain embodiments, crystallizing further includes heating the alkaline slurry to a temperature, and for a time, sufficient to crystallize at least about 5 wt. % zeolite, based on total weight of the FCC catalyst component, to form zeolitic microspheres.

In certain embodiments, the method includes, prior to crystallizing, forming the pure alumina particles, e.g., by milling an alumina particle precursor, slurrying the milled alumina particle precursor, and spray drying the slurried and milled alumina particle precursor to form alumina particles of a suitable size as described herein.

In certain embodiments, the method for preparing any of the FCC catalyst components further includes modifying the zeolitic microspheres (after crystallization) and/or the pure alumina particles (before crystallization) with a non-alumina constituent selected from a rare earth element, bismuth, an alkaline earth element, or a mixture of two or more thereof. Suitable rare earth elements may include ytterbium, gadolinium, cerium, lanthanum, or a mixture of two or more thereof. Suitable alkaline earth elements may include barium, strontium, calcium, magnesium, or a mixture of two or more thereof. In one embodiment, modifying may include impregnating or contacting the zeolitic microspheres and/or the pure alumina particles with a precursor solution of the selected non-alumina constituent (e.g., cerium nitrate, cerium acetate, lanthanum nitrate, lanthanum acetate).

In certain embodiments, the present disclosure provides a FCC catalyst composition that includes a first FCC catalyst component according to any of the embodiments described herein and a second component that is compositionally different from the first FCC catalyst component. The second component may include a second zeolite and a second non-zeolitic matrix. The second zeolite may be selected from zeolites with the structure BEA, MSE,-SVR, FAU, MOR, CON, SOF, MFI, IMF, FER, MWW, MTT, TON, EUO, MRE, NAT, CHA, EMT, or a combination thereof. The second matrix may include one or more of clay, spinel, mullite, boehmite, alumina, silica, titania, zirconia, magnesia, kaolin, metakaolin, halloysite, kaolinite, dickite, nacrite, anauxite, silica-alumina, silica-magnesia, silica-zirconia, silica-thoria, silica-beryllia, silica-titania, silica-alumina-thoria, silica-alumina-zirconia, silica-alumina-magnesia, silica-magnesia-zirconia, silica-doped alumina, gamma-alumina, x-alumina, 8-alumina, 0-alumina, κ-alumina, a-alumina, rare earth-modified variations thereof, alkaline earth metal-modified variations thereof, bismuth-modified variations thereof, or a mixture thereof.

In certain embodiments, the present disclosure provides a method for preparing a FCC catalyst composition by combining a first FCC catalyst component according to any of the embodiments described herein with a second component that is compositionally different from the first FCC catalyst component.

In certain embodiments, the present disclosure provides a method of cracking a hydrocarbon feed by contacting the fee with an FCC catalyst component according to any of the embodiments described herein or with an FCC catalyst composition according to any of the embodiments described herein. The methods of the instant disclosure may result in one or more of: enhanced light cycle oil (LCO) yield, enhanced liquefied petroleum gas (LPG) yield, and/or lower coke yield.

### Definitions

As used herein, the singular forms “a,” “an,” and “the” include plural references unless the context clearly indicates otherwise. Thus, for example, reference to “a microsphere” includes a single microsphere as well as a mixture of two or more microspheres, and the like.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. In certain embodiments, the term “about” includes the recited number ±10%, such that “about 10” would include from 9 to 11.

As used herein, the term “catalyst” or “catalyst composition” or “catalyst material” or “catalyst component” refers to a material that promotes a reaction. As used herein, the term “composition,” when referring to an FCC catalyst composition or an FCC additive composition, refers to a blend or a mixture of two or more separate and distinct components, such as a first component mixed or blended with a second component. In certain embodiments, the components in the composition are chemically combined and cannot be separated through physical means (e.g., filtration). In other embodiments, the components in the composition are not chemically combined and may be separated through physical means (e.g., filtration).

As used herein, the term “fluid catalytic cracking” or “FCC” refers to a conversion process in petroleum refineries wherein high-boiling, high-molecular weight hydrocarbon fractions of petroleum crude oils are converted to more valuable gasoline, olefinic gases, and other products.

“Cracking conditions” or “FCC conditions” refers to typical FCC process conditions. Typical FCC processes are conducted at reaction temperatures of 450° to 650° C. with catalyst regeneration temperatures of 600° to 850° C. Hot regenerated catalyst is added to a hydrocarbon feed at the base of a riser reactor. The fluidization of the solid catalyst particles may be promoted with a lift gas. The catalyst vaporizes and superheats the feed to the desired cracking temperature. During the upward passage of the catalyst and feed, the feed is cracked, and coke deposits on the catalyst. The coked catalyst and the cracked products exit the riser and enter a solid-gas separation system, e.g., a series of cyclones, at the top of the reactor vessel. The cracked products are fractionated into a series of products, including gas, gasoline, light gas oil, and heavy cycle gas oil. Some heavier hydrocarbons may be recycled to the reactor.

As used herein, the term “feed” or “feedstock” refers to that portion of crude oil that has a high boiling point and a high molecular weight. In FCC processes, a hydrocarbon feedstock is injected into the riser section of an FCC unit, where the feedstock is cracked into lighter, more valuable products upon contacting hot catalyst circulated to the riser-reactor from a catalyst regenerator.

As used herein, “particles” can be in the form of microspheres which can be obtained by spray drying. As is understood by skilled artisans, microspheres are not necessarily perfectly spherical in shape. The various catalyst components described herein may be particles in the form of microspheres.

As used herein, the terms “matrix” or “non-zeolitic matrix” refer to the constituents of an FCC catalyst component that are not zeolites or molecular sieves.

As used herein, the term “zeolite” refers to a crystalline aluminosilicate with a framework based on an extensive three-dimensional network of silicon, aluminum and oxygen ions and have a substantially uniform pore distribution.

As used herein, the term “intergrown zeolite” refers to a zeolite that is formed by an in-situ crystallization process.

As used herein, the term “in-situ crystallized” refers to the process in which a zeolite is grown or intergrown directly on/in a microsphere and is intimately associated with the matrix or non-zeolitic material, for example, as described in U.S. Pat. Nos. 4,493,902 and 6,656,347. The zeolite is intergrown directly on/in the macropores of the precursor microsphere such that the zeolite is intimately associated is uniformly dispersed on the matrix or non-zeolitic material.

As used herein, the term “incorporated catalyst” refers to a process in which the zeolitic component is crystallized and then incorporated into microspheres in a separate step.

As used herein, the terms “preformed microspheres” or “precursor microspheres” refer to microspheres obtained by spray drying and calcining a non-zeolitic component.

As used herein, the term “zeolite-containing microsphere” refers to a microsphere obtained either by in-situ crystallizing a zeolite material on pre-formed precursor microspheres or by microspheres in which the zeolitic component is crystallized separately and then mixed with the precursor microspheres.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

### DETAILED DESCRIPTION

This disclosure is directed in certain embodiments to a fluid catalytic cracking (FCC) catalyst component that includes an in-situ crystallized zeolite on pure alumina particles, wherein the FCC catalyst component has a ratio of zeolite surface area (ZSA) to matrix surface area (MSA), also may be referred to herein as Z/M ratio, of less than about 1.3. In certain embodiments, the Z/M ratio may be less than about 1.2, less than about 1.1, less than about 1.0, less than about 0.9, less than about 0.8, or less than about 0.7. In certain embodiments, the Z/M ratio may range from any of about 0.2, about 0.3, about 0.4, about 0.5, or about 0.6 to any of about 0.7, about 0.8, about 0.9, about 1.0, about 1.1, about 1.2, or about 1.3, or any sub-range or single Z/M value therein. In one embodiment, the Z/M ratio of the FCC catalyst component ranges from about 0.5 to about 1.3. In one embodiment, the Z/M ratio of the FCC catalyst component ranges from about 0.6 to about 1.3. In one embodiment, the Z/M ratio of the FCC catalyst component ranges from about 0.7 to about 1.3. It is believed, without being construed as limiting, that the light cycle oil (LCO) yield is a function of the Z/M of the FCC catalyst component such that for a given matrix technology, as Z/M ratio decreases, the LCO yield increases. LCO is a diesel fuel precursor and has been increasingly of greater interest in the FCC market.

In certain embodiments, the steamed Z/M ratio (sZ/M ratio), after the FCC catalyst component has been subjected to steaming conditions (e.g., 800° C. for, e.g., about 1-24 hours, at 100% steam), is less than about 1.0. In certain embodiments, the sZ/M ratio may be less than about 0.9, less than about 0.8, or less than about 0.7. In certain embodiments, the sZ/M ratio may range from any of about 0.2, about 0.25, or about 0.3 to any of about 0.4, about 0.5, about 0.6, about 0.7, about 0.8, about 0.9, or about 1.0, or any sub-range or single sZ/M value therein. In one embodiment, the sZ/M ratio of the FCC catalyst component ranges from about 0.2 to about 0.7. In one embodiment, the sZ/M ratio of the FCC catalyst component ranges from about 0.25 to about 0.6. In one embodiment, the sZ/M ratio of the FCC catalyst component ranges from about 0.3 to about 0.5.

To arrive at the Z/M ratio (or the sZ/M ratio), the total surface area (TSA) of the FCC catalyst component is obtained following the BET method and the matrix surface area (MSA) of the FCC catalyst component is obtained following the t-plot method. The difference between TSA and MSA is the zeolite surface area (ZSA) of the FCC catalyst component.

In certain embodiments, the BET TSA of the FCC catalyst component ranges from any of about 50 m²/g, about 75 m²/g, about 100 m²/g, or about 125 m²/g to any of about 150 m²/g, about 175 m²/g, about 200 m²/g, about 250 m²/g, about 275 m²/g, about 300 m²/g, about 350 m²/g, about 400 m²/g, about 450 m²/g, or about 500 m²/g, or any sub-range or single BET TSA value therein. In one embodiment, the BET TSA of the FCC catalyst component ranges from about 100 m²/g to about 300 m²/g. In one embodiment, the BET TSA of the FCC catalyst component ranges from about 125 m²/g to about 270 m²/g. In one embodiment, the BET TSA of the FCC catalyst component ranges from about 150 m²/g to about 250 m²/g.

In certain embodiments, the t-plot MSA of the FCC catalyst component ranges from any of about 25 m²/g, about 50 m²/g, about 75 m²/g, or about 90 m²/g to any of about 110 m²/g, about 125 m²/g, about 130 m²/g, about 140 m²/g, about 150 m²/g, about 160 m²/g, about 170 m²/g, about 175 m²/g, about 180 m²/g, or about 190 m²/g, or any sub-range or single t-plot MSA value therein. In one embodiment, the t-plot MSA of the FCC catalyst component ranges from about 25 m²/g to about 175 m²/g. In one embodiment, the t-plot MSA of the FCC catalyst component ranges from about 50 m²/g to about 150 m²/g. In one embodiment, the t-plot MSA of the FCC catalyst component ranges from about 75 m²/g to about 125 m²/g.

In certain embodiments, the ZSA of the FCC catalyst component ranges from any of about 25 m²/g, about 50 m²/g, about 75 m²/g, or about 90 m²/g to any of about 110 m²/g, about 125 m²/g, about 130 m²/g, about 140 m²/g, about 150 m²/g, about 160 m²/g, about 170 m²/g, about 175 m²/g, about 180 m²/g, or about 190 m²/g, or any sub-range or single ZSA value therein. In one embodiment, the ZSA of the FCC catalyst component ranges from about 25 m²/g to about 175 m²/g. In one embodiment, the ZSA of the FCC catalyst component ranges from about 50 m²/g to about 150 m²/g. In one embodiment, the ZSA of the FCC catalyst component ranges from about 75 m²/g to about 125 m²/g.

FCC catalyst components, according to embodiments described herein, may include a variety of zeolites, such as, without limitations, zeolites selected from zeolites with the structure BEA, MSE,-SVR, FAU, MOR, CON, SOF, MFI, IMF, FER, MWW, MTT, TON, EUO, MRE, NAT, CHA, EMT, or a mixture of two or more thereof. In certain embodiments, the zeolite is selected from zeolite X, Y-zeolite, ZSM-5, beta zeolite, ZSM-11, ZSM-14, ZSM-17, ZSM-18, ZSM-20, ZSM-31, ZSM-34, ZSM-41, ZSM-46, mordenite, chabazite, or mixtures of two or more thereof. In one embodiment, the zeolite is zeolite Y.

In some embodiments, the zeolite has a unit cell parameter of from about 24.10 Å to about 24.80 Å. In some embodiments, the zeolite has a unit cell parameter of from about 24.30 Å to about 24.75 Å. In some embodiments, the zeolite has a unit cell parameter of from about 24.50 Å to about 24.70 Å. In some embodiments, the zeolite has a unit cell parameter of from about 24.30 Å to about 24.40 Å. In some embodiments, the zeolite has a unit cell parameter of from about 24.50 Å to about 24.80 Å. Without being construed as limiting, it is believed that a relatively large effective unit cell size results in more liquefied petroleum gas (LPG). LPG has also been increasingly of greater interest in the FCC market.

In some embodiments, the zeolite has a unit cell parameter of from about 24.30 Å to about 24.75 Å. In some embodiments, the zeolite has a unit cell parameter of from about 24.30 Å to about 24.74 Å. In some embodiments, the zeolite has a unit cell parameter of from about 24.30 Å to about 24.73 Å. In some embodiments, the zeolite has a unit cell parameter of from about 24.30 Å to about 24.72 Å. In some embodiments, the zeolite has a unit cell parameter of from about 24.30 Å to about 24.71 Å. In some embodiments, the zeolite has a unit cell parameter of from about 24.50 Å to about 24.75 Å. In some embodiments, the zeolite has a unit cell parameter of from about 24.50 Å to about 24.74 Å. In some embodiments, the zeolite has a unit cell parameter of from about 24.50 Å to about 24.73 Å. In some embodiments, the zeolite has a unit cell parameter of from about 24.50 Å to about 24.72 Å. In some embodiments, the zeolite has a unit cell parameter of from about 24.50 Å to about 24.71 Å. In some embodiments, the zeolite has a unit cell parameter of from about 24.60 Å to about 24.75 Å. In some embodiments, the zeolite has a unit cell parameter of from about 24.60 Å to about 24.74 Å. In some embodiments, the zeolite has a unit cell parameter of from about 24.60 Å to about 24.73 Å. In some embodiments, the zeolite has a unit cell parameter of from about 24.60 Å to about 24.72 Å. In some embodiments, the zeolite has a unit cell parameter of from about 24.60 Å to about 24.71 Å. In some embodiments, the zeolite has a unit cell parameter of from about 24.65 Å to about 24.75 Å. In some embodiments, the zeolite has a unit cell parameter of from about 24.65 Å to about 24.74 Å. In some embodiments, the zeolite has a unit cell parameter of from about 24.65 Å to about 24.73 Å. In some embodiments, the zeolite has a unit cell parameter of from about 24.65 Å to about 24.72 Å. In some embodiments, the zeolite has a unit cell parameter of from about 24.65 Å to about 24.71 Å. In some embodiments, the zeolite has a unit cell parameter of from about 24.45 Å to about 24.75 Å. In some embodiments, the zeolite has a unit cell parameter of from about 24.45 Å to about 24.74 Å. In some embodiments, the zeolite has a unit cell parameter of from about 24.45 Å to about 24.73 Å. In some embodiments, the zeolite has a unit cell parameter of from about 24.45 Å to about 24.72 Å. In some embodiments, the zeolite has a unit cell parameter of from about 24.45 Å to about 24.71 Å. In some embodiments, the zeolite has a unit cell parameter of about 24.10 Å, 24.11 Å, 24.12 Å, 24.13 Å, 24.14 Å, 24.15 Å, 24.16 Å, 24.17 Å, 24.18 Å, 24.19 Å, 24.20 Å, 24.21 Å, 24.22 Å, 24.23 Å, 24.24 Å, 24.25 Å, 24.26 Å, 24.27 Å, 24.28 Å, 24.29 Å, 24.30 Å, 24.31 Å, 24.32 Å, 24.33 Å, 24.34 Å, 24.35 Å, 24.36 Å, 24.37 Å, 24.38 Å, 24.39 Å, 24.40 Å, 24.41 Å, 24.42 Å, 24.43 Å, 24.44 Å, 24.45 Å, 24.46 Å, 24.47 Å, 24.48 Å, 24.49 Å, 24.50 Å, 24.51 Å, 24.52 Å, 24.53 Å, 24.54 Å, 24.55 Å, 24. 56 Å, 24.57 Å, 24.58 Å, 24.59 Å, 24.60 Å, 24.61 Å, 24.62 Å, 24.63 Å, 24.64 Å, 24.65 Å, 24.66 Å, 24.67 Å, 24.68 Å, 24.69 Å, 24.70 Å, 24.71 Å, 24.72 Å, 24.73 Å, 24.74 Å, 24.75 Å, 24.76 Å, 24.77 Å, 24.78 Å, 24.79 Å, or 24.80 Å.

The above unit cell sizes may be particularly suitable for zeolites having FAU zeolite structure, such as zeolite Y. As understood by those skilled in the art, some of the zeolite structures described hereinabove may have different unit cell dimensions from those recited herein.

The pure alumina particles in the FCC catalyst components contemplated herein may include one or more of alumina derived from boehmite, alumina derived from pseudo boehmite, alumina derived from flash calcined gibbsite, boehmite, pseudo boehmite, flash calcined gibbsite, calcined flash calcined gibbsite, silica-doped alumina, gamma-alumina, χ-alumina, δ-alumina, θ-alumina, κ-alumina, α-alumina, rare earth-modified variations thereof, alkaline earth metal-modified variations thereof, bismuth-modified variations thereof, or a mixture of two or more thereof. In certain embodiments, the pure alumina particles include one or more of alumina derived from boehmite, alumina derived from pseudo boehmite, alumina derived from flash calcined gibbsite, flash calcined gibbsite, calcined flash calcined gibbsite, gamma-alumina, rare earth-modified variations thereof, alkaline earth metal-modified variations thereof, or a mixture of two or more thereof. In one embodiment, the pure alumina particles comprise lanthanum doped gamma alumina derived from calcination of boehmite and/or pseudo boehmite and modified with a lanthanum precursor. In one embodiment, the pure alumina particles comprise calcined flash calcined gibbsite that may include chi alumina, an alumina that is similar to gamma-alumina, or a combination thereof.

As used herein, “flash calcined gibbsite,” refers to gibbsite that has been passed through a hot column, e.g., at a temperature of about 500° C. and 800° C., to form a mixture of steam and a substantially anhydrous alumina, wherein said substantially anhydrous alumina is referred to as flash calcined gibbsite. The term “calcined flash calcined gibbsite,” refers to flash calcined gibbsite that has been subjected to further calcination, e.g., at about 650° C. to about 900° C., about 700° C. to about 900° C., about 750° C. to about 850° C., or about 800° C.

In certain embodiments, one or more of the above-recited pure alumina particles form the entirety of the non-zeolitic matrix of the FCC catalyst component. In one embodiment, the FCC catalyst component is free or substantially free (i.e., has less than about 15 wt. %, less than about 12 wt. %, less than about 10 wt. %, less than about 8 wt. %, less than about 5 wt. %, less than about 3 wt. %, less than about 1 wt. %, or 0 wt. %, based on total weight of the FCC catalyst component) of clay. Without being construed as limiting, it is believed that an alumina matrix (i.e., a non-zeolitic matrix that includes one or more of the above recited pure alumina particles) is better than a clay matrix at coke minimization.

There are several theories as to the reasons that a clay matrix may be inferior to a pure alumina particles matrix at coke minimization.

One reason may be, without being construed as limiting, that spinel has a relatively high levels of strong Lewis acid sites, which may bind tightly to hydrocarbon fragments. The hydrocarbons that do not desorb and get to the regenerator are coke. The pure alumina particles may, in certain embodiments, may have a strong Lewis acid site density of less than about 70 μmol/g, less than about 65 μmol/g, less than about 60 μmol/g, less than about 55 μmol/g, less than about 50 μmol/g, less than about 45 μmol/g, less than about 40 μmol/g, or any sub-range or single Lewis acid density value therein.

Another reason for a clay matrix being inferior to a pure alumina particles matrix at coke minimization is believed, without being construed as limiting, to be related to the iron content in the clay. Under FCC riser conditions, the Fe (III)/Fe (II) redox couple may be active and iron may catalyze initiation of radical reactions in addition to acid-catalyzed cracking. Radical coupling of large hydrocarbon fragments may result in larger hydrocarbon intermediates that do not desorb, report to the regenerator, and constitute coke. The pure alumina particles may, in certain embodiments, be free or substantially free (i.e., has less than about 15 wt. %, less than about 12 wt. %, less than about 10 wt. %, less than about 8 wt. %, less than about 5 wt. %, less than about 3 wt. %, less than about 1 wt. %, or 0 wt. %, based on total weight of the pure alumina particles) of iron.

The pure alumina particles may have an average particle size of about 40 μm to about 150 μm, about 60 μm to about 120 μm, or about 80 μm to about 100 μm. In one embodiment, the particle size distribution of the pure alumina particles may be tight and the average size of the particles may range from about 70 μm to about 90 μm or about 80 μm to about 90 μm. In one embodiment, the pure alumina particles undergo one or more of: milling (e.g., dry milling such as, without limitations, chop milling, hammer milling, or ball milling), slurrying, and/or spray drying to arrive at an average particle size of about 40 μm to about 150 μm, about 60 μm to about 120 μm, about 80 μm to about 100 μm, or about 70 μm to about 90 μm. In another embodiment, pure alumina particles may be wet milled and then spray dried to arrive at an average particle size of about 40 μm to about 150 μm, about 60 μm to about 120 μm, about 80 μm to about 100 μm, or about 70 μm to about 90 μm. In an alternative embodiment, the pure alumina particles are unmilled and have an average particle size of about 40 μm to about 150 μm, about 60 μm to about 120 μm, about 80 μm to about 100 μm, or about 70 μm to about 90 μm. Pure alumina particles that are coarse enough without milling, slurrying, and spray drying may be preferred in certain instances due to the reduced expense that may be otherwise associated with additional process steps (such as milling, slurrying, and spray drying).

In some embodiments, the pure alumina particles are present in the FCC catalyst component in an amount ranging from any of about 50 wt. %, about 55 wt. %, about 60 wt. %, about 65 wt. %, about 70 wt. %, or about 75 wt. % to any of about 80 wt. %, about 85 wt. %, about 90 wt. %, or about 95 wt. %, or any sub-range or single concentration value therein, based on the total weight of the FCC catalyst component.

Any of the pure alumina particles and/or the zeolites in the FCC catalyst components described herein may be further modified by a non-alumina constituent such as, without limitations, from a rare earth element, bismuth, an alkaline earth element, or a mixture of two or more thereof. In some embodiments, the non-alumina constituent is present in the FCC catalyst component in an amount ranging from any of about 0.1 wt. %, about 0.5 wt. %, about 1 wt. %, about 2 wt. %, about 3 wt. %, about 4 wt. %, or about 5 wt. % to any of about 6 wt. %, about 7 wt. %, about 8 wt. %, about 9 wt. %, about 10 wt. %, about 11 wt. %, about 12 wt. %, about 13 wt. %, about 14 wt. %, or about 15 wt. %, or any sub-range or single concentration value therein, based on the total weight of the FCC catalyst component. In certain embodiments, the non-alumina constituent is present in the FCC catalyst component in an amount ranging from about 0.1 wt. % to about 12 wt. %, from about 1 wt. % to about 10 wt. %, from about 1 wt. % to about 5 wt. %, or from about 1 wt. % to about 3 wt. %, or any sub-range or single concentration values therein, based on the total weight of the FCC catalyst component.

In one embodiment, the pure alumina particles and/or the zeolites in the FCC catalyst components described herein are modified with a rare earth element. Suitable rare earth elements include, without limitations, ytterbium, gadolinium, cerium, lanthanum, or a mixture of two or more thereof. In one embodiment, the pure alumina particles and/or the zeolites in the FCC catalyst components described herein are modified with cerium, e.g., from about 0.1 wt. % to about 15 wt. %, from about 3 wt. % to about 15 wt. %, from about 5 wt. % to about 15 wt. %, or from about 10 wt. % to about 15 wt. % cerium, based on the total weight of the FCC catalyst component. In one embodiment, the pure alumina particles and/or the zeolites in the FCC catalyst components described herein are modified with lanthanum, e.g., from about 0.1 wt. % to about 12 wt. %, from about 1 wt. % to about 10 wt. %, from about 1 wt. % to about 5 wt. %, or from about 1 wt. % to about 3 wt. % lanthanum, based on the total weight of the FCC catalyst component. In one embodiment, the pure alumina particles and/or the zeolites in the FCC catalyst components described herein are modified with lanthanum and cerium.

In certain embodiments, modifying the pure alumina particles with lanthanum may beneficially promote bottoms conversion to light cycle oil (LCO) and may contribute to the enhanced LCO yield exhibited by the FCC catalyst components contemplated herein.

In one embodiment, the pure alumina particles and/or the zeolites in the FCC catalyst components described herein are modified with an alkaline earth element. Suitable alkaline earth element include, without limitations, barium, strontium, calcium, magnesium, or a mixture of two or more thereof. In one embodiment, the pure alumina particles and/or the zeolites in the FCC catalyst components described herein are modified with strontium.

In certain embodiments, this disclosure is directed to a method for preparing any of the FCC catalyst components described herein by crystallizing, in-situ, a zeolite on pure alumina particles, wherein the FCC catalyst component has a Z/M ratio of less than about 1.3. In certain embodiments, the Z/M ratio may be less than about 1.2, less than about 1.1, less than about 1.0, less than about 0.9, less than about 0.8, or less than about 0.7. In certain embodiments, the Z/M ratio may range from any of about 0.2, about 0.3, about 0.4, about 0.5, or about 0.6 to any of about 0.7, about 0.8, about 0.9, about 1.0, about 1.1, about 1.2, or about 1.3, or any sub-range or single Z/M value therein. Any of the zeolites described hereinbefore may be crystallized on any of the pure alumina particles described hereinbefore.

In certain embodiments, the FCC catalyst components exhibit a pore volume of at least about 0.15 mL/g, at least about 0.20 mL/g, at least about 0.25 mL/g, at least about 0.30 mL/g, at least about 0.35 mL/g, at least about 0.40 mL/g, at least about 0.45 mL/g, or within any range defined therebetween (e.g., from about 0.15 mL/g to about 0.45 mL/g), as measured by mercury porosimetry using a mercury porosimeter such as, for example, Micromeritics Autopore IV or Micromeritics Autopore V.

In certain embodiments, the method for preparing any of the FCC catalyst components may further include, prior to crystallizing, preparation of the pure alumina particles. In one embodiment, preparing the pure alumina particles includes milling an alumina precursor (e.g., a precipitated alumina made from boehmite or from pseudo boehmite), making a slurry of the milled alumina precursor and optionally sodium silicate sol, and spray drying the slurried and milled alumina precursor with optional sodium silicate sol to arrive at an average particle size of about 40 μm to about 150 μm, about 60 μm to about 120 μm, or about 80 μm to about 100 μm. In an alternative embodiment, preparing the pure alumina particles may not involve a milling and spray drying step, for instance, if the pure alumina particles are already sufficiently coarse and have an average particle size of about 40 μm to about 150 μm, about 60 μm to about 120 μm, or about 80 μm to about 100 μm.

In certain embodiments, preparing the pure alumina particles may further include modifying the pure alumina particles with one or more of rare earth element, bismuth, or alkaline earth element. In one embodiment, preparing the pure alumina particles includes modifying the pure alumina particles with a rare earth element. Suitable rare earth elements include, without limitations, ytterbium, gadolinium, cerium, lanthanum, or a mixture of two or more thereof. In one embodiment, preparing the pure alumina particles includes modifying the pure alumina particles with cerium. Modifying the pure alumina particles with cerium may include impregnating the pure alumina particles with a cerium precursor, such as cerium nitrate or cerium acetate. In one embodiment, preparing the pure alumina particles includes modifying the pure alumina particles with lanthanum. Modifying the pure alumina particles with lanthanum may include impregnating the pure alumina particles with a lanthanum precursor, such as lanthanum nitrate or lanthanum acetate.

In certain embodiments, preparing the pure alumina particles may further include modifying the pure alumina particles with an alkaline earth element. Suitable alkaline earth element include, without limitations, barium, strontium, calcium, magnesium, or a mixture of two or more thereof. In one embodiment, preparing the pure alumina particles includes modifying the pure alumina particles with strontium. Modifying the pure alumina particles with strontium may include impregnating the pure alumina particles with a strontium precursor, such as strontium nitrate or strontium acetate.

In certain embodiments, preparing the pure alumina particles may further include calcining the pure alumina particles (e.g., at about 700° C. to about 900° C., or about 750° C. to about 850° C., or about 800° C.). Calcining the pure alumina particles may occur before the particles are modified (e.g., impregnated) with a rare earth precursor, alkaline earth element precursor, or a bismuth precursor; after the particles are modified with any of the above; or both, before and after, the particles are modified with any of the above.

For the crystallization step in the method of preparing the FCC catalyst components described herein, any of the pure alumina particles described herein may be mixed with an aluminum source, a silicon source, water, and optionally sodium hydroxide to obtain an alkaline slurry. Seeds (such as those described in U.S. Pat. No. 4,631,262, the teachings of which are incorporated by reference in their entirety) may also be added to said slurry. Thereafter, the alkaline slurry may be heated to a temperature, and for a time, sufficient to crystallize at least about 5 wt. % zeolite, based on total weight of the FCC catalyst component, to form zeolitic microspheres. The phase composition of the zeolite (e.g., zeolite Y) may range from any of about 5 wt. %, about 6 wt. %, about 7 wt. %, or about 8 wt. % to any of about 15 wt. %, about 17 wt. %, about 20 wt. %, or about 25 wt. %, or any sub-range or single phase composition therein, based on total weight of the FCC catalyst component.

Suitable sacrificial aluminum sources for the zeolite crystallization may include, without limitations, metakaolin, sodium aluminate, or a combination thereof.

In certain embodiments, the method for preparing the FCC catalyst components described herein also includes preparation of sacrificial aluminum source particles. In one embodiment, the aluminum source particles are derived from calcining kaolinite at a temperature, and for a duration, sufficient to transform the kaolinite to metakaolin without forming spinel. In one embodiment, the aluminum source is metakaolin.

Preparing sacrificial aluminum source particles from calcining kaolinite may, in certain instances, introduce some iron into the FCC catalyst component. In certain embodiments, higher iron content may be less desirable due to its potential contribution to coke formation. Hence, in certain embodiments, the sacrificial aluminum source is one that does not contain iron, such as, without limitations, sodium aluminate. Without being construed as limiting, it was observed that when sodium aluminate was used as the sacrificial aluminum source for Y-zeolite crystallization, if the sodium aluminate was added all at once, Y zeolite did not grow. When sodium aluminate was added slowly, over time, Y zeolite grew. Hence, when sodium aluminate sol is used for the zeolite crystallization, it is added slowly (thereby also mimicking the slow dissolution of metakaolin that occurs during Y zeolite crystallization with metakaolin as the sacrificial aluminum source). Slow addition of the sodium aluminate sol is believed to provide for better control of the zeolite phase and hydrothermal stability thereof.

Although kaolinite (and the resulting metakaolin) includes aluminum and silicon at an atomic ratio of Si/Al of 1.0, the metakaolin by itself may provide insufficient amount of silicon to crystallize certain zeolites with a Si/Al ratio greater than 1.0. For instance, zeolite Y has an atomic ratio of Si/Al of 2.5 and would necessitate a secondary silicon source, in addition to metakaolin, to facilitate zeolite Y growth.

Suitable sacrificial silicon sources for the zeolite crystallization may include, without limitations, sodium silicate, quartz, silica gel, silica sol, sodium silicate sol, and a combination thereof. In one embodiment, the silicon source used includes sodium silicate sol (e.g., mostly water containing sodium silicate which may be made by dissolving solid sodium silicate in water). In one embodiment, the silicon source used includes silica gel. In one embodiment, the silicon source used includes quartz.

When sodium silicate sol is used as the sacrificial silicon source for Y-zeolite crystallization, it may be added all at once at the beginning of the zeolite crystallization or zeolite growth reaction. Other sacrificial silicon sources, such as, without limitations, silica gel or quartz, do not bring sodium into the zeolite crystallization reaction and may be used to give more flexibility in tuning the amount of sodium and silica present in zeolite crystallization, since the two constituents (sodium and silica) can be separately added. In contrast, sodium silicate (or sodium silicate sols) already include sodium therein, which provides less flexibility in tuning the amount of sodium and silica present during zeolite crystallization. This may pose some challenges or result in added process steps because the sodium to silica ratio in sodium silicates (or sodium silicate sols) may be high, which may contribute to rapid zeolite growth. A rapid zeolite growth may be less favorable due to its potential adverse effect on the hydrothermal stability of the crystallized zeolite and/or due to its contribution to the growth of less favorable zeolite phase (such as GIS or GNE zeolite structures).

After the crystallization step in the method of preparing the FCC catalyst components described herein, in certain embodiments, the method further includes isolating or separating the zeolitic microspheres from the alkaline slurry. Isolating or separating the zeolitic microspheres may be carried out by commonly used methods such as filtration. In certain embodiments, the zeolitic microspheres may be washed or contacted with water or other suitable liquid to remove residual crystallization liquor.

In certain embodiments, the method of preparing the FCC catalyst components described herein further includes ion-exchanging the zeolite (e.g., ion-exchanging the Y-zeolite) to reduce sodium content in said FCC catalyst component and/or to replace the sodium ions with other more favorable ions. For instance, in one embodiment, the Y zeolite is ion-exchanged to reduce the sodium content of the FCC catalyst component to less than about 0.7 wt. %, less than about 0.5 wt. %, or less than about 0.3 wt. % Na₂O, based on the total weight of the FCC catalyst component. Ion-exchanging may be conducted once, twice, three times, four times, five times, six times, or as many times as needed to arrive at a target sodium content.

In certain embodiments, the sodium ions may be replaced by other ions, for instance, by ion-exchanging ammonium cations, rare earth metals, or a combination thereof, to arrive at an FCC catalyst component that includes a zeolite that is modified with more favorable cations.

In some embodiments, the method may further include mixing the zeolitic microspheric material with an ammonium nitrate solution prior to or subsequent to contacting zeolite in the sodium form prior to the mixing with the ammonium nitrate solution. In some embodiments, the mixing with the ammonium nitrate solution is conducted at acidic pH conditions. In some embodiments, the mixing with the ammonium nitrate solution is conducted at pH of about 3 to about 3.5. In some embodiments, the mixing with the ammonium nitrate solution is conducted at a temperature above room temperature. In some embodiments, the mixing with the ammonium nitrate solution is conducted at a temperature of at least about 80° C. to about 100° C., including increments therein. In certain embodiments, ion-exchanging the zeolitic microspheric material with ammonium cations reduces the sodium content of the zeolitic microspheric material to from about 1 wt. % Na₂O to about 2 wt. % Na₂O, based on total weight of the FCC catalyst component.

In some embodiments, the ammonium exchanged microspheric material is further ion exchanged with a rare earth ion solution. In some embodiments, the rare earth ion are nitrates of ytterbium, neodymium, samarium, gadolinium, cerium, lanthanum, or a mixture of any two or more such nitrates. In some embodiments, the rare earth ions are derived from the lanthanides or yttrium. In some embodiments, the microspheres are contacted with solutions of lanthanum nitrate or yttrium nitrate. In particular embodiments, the microspheres are contacted with solutions of lanthanum nitrate. Rare earth levels in the range of about 0.1 wt. % to about 12 wt. %, about 1 wt. % to about 5 wt. %, or about 2 wt. % to about 3 wt. %, based on the total weight of the FCC catalyst component, are contemplated. In certain embodiments, the amount of rare earth added to the catalyst as a rare earth oxide will range from about 1 wt. % to about 5 wt. %, or from about 2 wt. % to about 3 wt. % rare earth oxide (REO), based on the total weight of the FCC catalyst component. In one embodiment, the FCC catalyst component includes lanthana at a concentration ranging from about 0.5 wt. % to about 7 wt. %, about 1 wt. % to about 6 wt. %, or about 2 wt. % to about 5 wt. %, based on the total weight of the FCC catalyst component.

In certain embodiments, the method further includes calcining the zeolitic microspheres. The calcination may be conducted for at least about two hours. In certain embodiments, the calcining is conducted at a temperature of from about 500° C. to about 750° C. In certain embodiments, the calcination may be conducted in the presence of about 25% v/v steam.

In certain embodiments, after calcination, the FCC catalyst component may be subjected to an additional ammonium nitrate solution ion exchange to further reduce the sodium content in the FCC catalyst component. In one or more embodiments, the ion exchange step or steps are carried out so that the resulting FCC catalyst component contains less than about 0.2 wt. % Na₂O (e.g., about 0.02 wt. % Na₂O to about 0.2 wt. % Na₂O), based on the total weight of the FCC catalyst component. After ion exchange, the microspheres may be calcined again (e.g., at a temperature of about 500° C. to about 750° C.).

In certain embodiments, the method of preparing the FCC catalyst components described herein further includes steam-treating the FCC catalyst component. In some embodiments, the steam-treating is conducted at a temperature of at least about 700° C. (e.g., about 750° C. or about 800° C.). In some embodiments, the steam-treating is conducted for at least about four hours. In some embodiments, the steam-treating is conducted for about one to about 24 hours. In some embodiments, the final step is conducted in a rotary calciner. In some embodiments, the final step is conducted in a fluid bed calciner.

Although the crystallization technique described herein refers to an in-situ technique in which the zeolite is crystallized on and/or in pre-formed pure alumina particles, the FCC catalyst component may also be prepared via an incorporation technique, in which the zeolite is crystallized separately and thereafter is incorporated into the pure alumina particles in a separate step.

The zeolite may be incorporated into a binder that includes any of the pure alumina particles described herein. In some embodiments, a slurry containing zeolite and a binder that includes any of the pure alumina particles described herein is made and spray dried to yield FCC catalyst component microspheres whose average particle size range from about 40 μm to about 150 μm, about 60 μm to about 120 μm, or about 80 μm to about 100 μm.

Crystal size of zeolite material in FCC catalysts varies considerably depending on method of making, materials, etc. The FCC catalyst material of this disclosure was analyzed for crystal size using two methods, X-ray diffraction (XRD) and scanning electron microscope (SEM) analysis.

Crystal size and anisotropy as measured by XRD can be expressed by two equations, the equations for isotropic size and anisotropic size, with an isotropic size parameter and an anisotropy parameter describing the crystal properties. Average isotropic size Sᵢ is given by

$${S}_{i} = 18000 \times K \times \frac{λ}{π \times {p}_{i}} ,$$

where K is the Scherrer constant (0.9 is used in this work), λ is the wavelength of x-rays used in the analysis (1.5406 Å in this work), and pᵢ is an isotropic size parameter. Average anisotropic size (i.e., the perpendicular size to the isotropic size) Sa is given by

$${S}_{a} = 1800 \times K \times \frac{λ}{π \times ( {p}_{i} + {p}_{a} )} ,$$

where pₐ is a parameter describing the anisotropy of the crystals. XRD analysis provides a volume-weighted average crystal size.

XRD isotropic crystal size of the FCC catalyst component of this disclosure may be between about 300 Å and about 550 Å. In some embodiments, XRD isotropic crystal size may be between about 350 Å and about 450 Å. XRD anisotropy parameter pₐ of fresh (e.g., pre-steam treatment) catalyst may have a magnitude between about 3.5 and about 5.

An interesting feature of the FCC catalyst component disclosed herein is the shift in crystal size upon steam deactivation. Experimental XRD evidence shows that the isotropic crystal size does not change significantly (i.e., within experimental error) upon steam treating. However, the catalyst disclosed herein does change shape when deactivated, with the steamed catalyst having an anisotropy parameter pₐ within experimental error of zero. Previous catalysts do not show this behavior upon steaming.

In certain embodiments, the a magnitude of the XRD anisotropy parameter pₐ of the steamed FCC catalyst component is less than about 1.0, less than about 0.9, less than about 0.8, less than about 0.7, less than about 0.6, or less than about 0.5.

As used herein, strain (S, in %) is computed according to:

$$S = \frac{π}{18000} ( Y - {Y}_{1} ) 100 \% ,$$

where Y is the LY parameter of the lineshape function used in the General Structure Analysis System (GSAS). Crystallite size (in Angstroms) is computed as:

$$p = \frac{18000 K λ}{π X} ,$$

and anisotropic particle size components are given by:

$${p}_{‖} = \frac{18000 K λ}{π ( X + {X}_{e} )} ,$$

where K is the Scherrer constant (a value of K=0.9 is used, which is often used by X-ray diffraction practitioners), lambda is the wavelength (Cu K-alpha radiation with a wavelength of 1.5406 Angstroms is used), X is the LX parameter, and Xₑ is the parameter called ptec with the lineshape function in GSAS (Function #4).

### FCC Catalyst Composition

In certain embodiments, the instant disclosure is directed to an FCC catalyst composition that includes any of the FCC catalyst components contemplated by the instant disclosure (e.g., those that include a zeolite crystallized in-situ on pure alumina particles and have a Z/M ratio of about 1.3 or less) with a second component that is compositionally different from the FCC catalyst component. In certain embodiments, the second component includes a second zeolite and a second non-zeolitic matrix.

The second zeolite may be selected from zeolites with the structure BEA, MSE,-SVR, FAU, MOR, CON, SOF, MFI, IMF, FER, MWW, MTT, TON, EUO, MRE, NAT, CHA, EMT, or a combination thereof.

In certain embodiments, the second zeolite may include (1) large pore zeolites (e.g., those having pore openings greater than about 7 Angstroms) such as, for example, USY, REY, silicoaluminophosphates SAPO-5, SAPO-37, SAPO-40, MCM-9, metalloaluminophosphate MAPO-36, aluminophosphate VPI-5, or mesoporous crystalline material MCM-41; REUSY, zeolite Z, zeolite Y, dealuminated zeolite Y, silica-enriched dealuminated zeolite Y, zeolite Beta, ZSM-3, ZSM-4, ZSM-18, ZSM-20, and EMT, (2) medium pore zeolites (e.g., those having pore openings of from about 4 Angstroms to about 7 Angstroms) such as, for example, ZSM-5, MCM-68, ZSM-11, ZSM-5, ZSM-11 intermediates, ZSM-12, ZSM-22, ZSM-23, ZSM-35, ZSM-38, ZSM-48, ZSM-57 silicoaluminophosphate SAPO-31 and (3) small pore zeolites (e.g., those having pore openings of less than about 4 Angstroms) such as, for example, erionite and ZSM-34.

In certain embodiments, the second zeolite may include zeolite A, zeolite B, zeolite F, zeolite H, zeolite K-G, zeolite L, zeolite M, zeolite Q, zeolite R, zeolite T, mordenite, erionite, offretite, ferrierite, chabazite, clinoptilolite, gmelinite, phillipsite and faujasite.

Hydrothermally and/or chemically modified versions of many of the components described above may also be suitable as the second component in the FCC catalyst compositions contemplated herein.

In certain embodiments, the second non zeolitic matrix in the second component may include one or more of clay, spinel, mullite, boehmite, alumina, silica, titania, zirconia, magnesia, kaolin, metakaolin, halloysite, kaolinite, dickite, nacrite, anauxite, silica-alumina, silica-magnesia, silica-zirconia, silica-thoria, silica-beryllia, silica-titania, silica-alumina-thoria, silica-alumina-zirconia, silica-alumina-magnesia, silica-magnesia-zirconia, silica-doped alumina, gamma-alumina, x-alumina, 8-alumina, 0-alumina, κ-alumina, α-alumina, rare earth-modified variations thereof, alkaline earth metal-modified variations thereof, bismuth-modified variations thereof, or a mixture thereof.

In certain embodiments, the second component may further include, as part of the second zeolite and/or as part of the second non-zeolitic matrix, a rare earth element, an alkaline earth element, bismuth, or a mixture of two or more such elements. Suitable rare earth elements include ytterbium, gadolinium, cerium, lanthanum, praseodynmium, neodymium, or a mixture of any two or more thereof. Suitable alkaline earth elements include barium, calcium, strontium, magnesium, or a mixture of any two or more thereof.

Any of the FCC catalyst components contemplated by the instant disclosure may be included in the FCC catalyst composition in an amount ranging from any of 1 wt. %, about 5 wt. %, about 10 wt. %, about 15 wt. %, about 20 wt. %, or about 25 wt. % to any of about 50 wt. %, about 60 wt. %, about 70 wt. %, about 80 wt. %, about 90 wt. %, or about 95 wt. %, or any sub-range or single value therein, based on total weight of the FCC catalyst composition.

Any second components described herein may be included in the FCC catalyst composition in an amount ranging from any of 5 wt. %, about 10 wt. %, about 20 wt. %, about 30 wt. %, about 40 wt. %, or about 50 wt. % to any of about 75 wt. %, about 80 wt. %, about 85 wt. %, about 90 wt. %, about 95 wt. %, or about 99 wt. %, or any sub-range or single value therein, based on total weight of the FCC catalyst composition.

The FCC catalyst composition may be formed by combining, such as by blending or mixing (e.g., physically mixing), any of the FCC catalyst components contemplated by the instant disclosure with any of the second components described herein.

### Method of Use

In certain aspects, the instant disclosure is directed to a method of cracking a hydrocarbon feed by contacting said feed with any of the FCC catalyst components contemplated by the instant disclosure (e.g., those that include a zeolite crystallized in-situ on pure alumina particles and have a Z/M ratio of about 1.3 or less) or with any of the FCC catalyst compositions described herein.

In certain embodiments, the methods of cracking a hydrocarbon feed, as described herein, result in enhanced light cycle oil (LCO) yield. For instance, it is believed that LCO yield is a function of the Z/M ratio and that for a given matrix technology, as the Z/M decreases, the LCO yield increases. As such, in certain embodiments, the methods described herein result in a LCO yield that is greater than the LCO yield resulting from contacting the hydrocarbon feed with a FCC catalyst component that has a Z/M ratio of about 1.3 or higher (while otherwise being the same aside from the Z/M ratio).

In certain embodiments, the methods of cracking a hydrocarbon feed, as described herein, result in enhanced liquefied petroleum gas (LPG) yield. For instance, it is believed that relatively large effective unit cell parameters result in increased LPG yield. As such, in certain embodiments, the methods described herein result in a LPG yield that is greater than the LPG yield resulting from contacting the hydrocarbon feed with a FCC catalyst component that has a unit cell size that is below 24.50 Å (while otherwise being the same aside from the unit cell size dimensions).

In certain embodiments, the methods of cracking a hydrocarbon feed, as described herein, result in a reduced coke yield. It is believed that forming the non-zeolitic matrix of the FCC catalyst component from pure alumina particles, rather than a traditional clay matrix, yields less coke. As such, in certain embodiments, the methods described herein result in a coke yield that is lower than the coke yield resulting from contacting the hydrocarbon feed with a FCC catalyst component that includes a non-zeolitic matrix that includes clay instead of at least part of the pure alumina particles (while otherwise being the same aside from the non-zeolitic matrix material).

### ILLUSTRATIVE EXAMPLES

The following examples are set forth to assist in understanding the disclosure and should not be construed as specifically limiting the invention described and claimed herein. Such variations of the invention, including the substitution of all equivalents now known or later developed, which would be within the purview of those skilled in the art, and changes in formulation or minor changes in experimental design, are to be considered to fall within the scope of the invention incorporated herein.

### Example 1: In-Situ Crystallization of Y-Zeolite on Pure Lanthanum-Doped Gamma Alumina Particles

Y zeolite was crystallized in-situ on previously spray-dried pure alumina particles, which were lanthanum-doped gamma alumina. The lanthanum-doped gamma alumina was a precipitated alumina, made from pseudo boehmite, and contained about 4 wt. % La₂O₃, based on total weight of the lanthanum-doped gamma alumina. These pure alumina particles were screened coarser than 325 mesh (or 44 μm).

The coarse pure alumina particles, having a particle size of 44 μm or greater, were combined with seeds, sodium silicate, sacrificial iron containing metakaolin microspheres (made by calcining kaolin clay to a temperature sufficient to transform kaolinite to metakaolin but at a calcination severity low enough that spinel was not made), caustic, and water to form three alkaline slurries. The alkaline slurries were heated to a temperature of about 82-99° C. for a duration of about 16-19 hours, sufficient to crystallize in-situ Y zeolite on the coarse pure lanthanum-doped gamma alumina particles to form zeolitic microspheres.

The zeolitic microspheres were separated from the alkaline slurries, washed, calcined and characterized. The properties of the resulting zeolitic microspheres are summarized in Table 1 below.

TABLE 1
Properties of Zeolitic Microspheres

| Property | Sample 1 | Sample 2 | Sample 3 |
|---|---|---|---|
| Total Surface Area (TSA) | 179 | 201 | 209 |
| Matrix Surface Area (MSA) | 106 | 95 | 92 |
| Zeolite Surface Area (ZSA) | 73 | 106 | 117 |
| Zeolite Y Content by ZSA | 11 | 16 | 18 |
| Zeolite Y Content by | 10 | 14 | 17 |
| X-Ray Diffraction (XRD) | | | |
| Zeolite Y by Theoretical Yield | 8 | 15 | 22 |
| ZSA/MSA Ratio (also “Z/M ratio”) | 0.69 | 1.12 | 1.27 |
| Unit Cell Size (ucs) of NaY zeolite | 24.669 | 24.667 | 24.673 |
| Projected Steamed Z/M ratio (sZ/M) | 0.28 | 0.45 | 0.51 |

### Example 2

A coarse gibbsite, consisting of agglomerates of hexagonal prism gibbsite crystals with agglomerate size of about 90 μm, on average, was flash calcined. The flash calcined gibbsite particles were calcined, in a rotary calciner, to a surface area of about 100 m²/g. The pore volume of these particles was about 0.2 ml/g according to mercury intrusion estimates. These particles were crystallized using standard in situ procedures, based on those described in U.S. Pat. No. 4,235,753. 7.5% of the microsphere mass was from spray dried kaolin particles that were calcined to convert kaolinite to metakaolin. Without being bound by theory, it is believed that aluminum from metakaolin is the limiting reagent in Y zeolite crystallization. 92.5% of the microsphere mass was the coarse, calcined flash calcined gibbsite. In addition, zeolite seeds (based on those described in U.S. Pat. No. 4,631,262), sodium silicate with 3.22 modulus, caustic, and water were ingredients used in crystallization, which was conducted at 88° C. Fine metakaolin particles were used so that the coarse calcined flash calcined gibbsite could be separated, using screens, from solids derived from metakaolin. As expected, Y zeolite grew in both fractions. Most of the zeolite grown, on a mass basis, grew in the coarse calcined flash calcined gibbsite fraction. As the catalyst was processed and steamed, physical properties were measured. Most properties evolved normally except for zeolite stability. After steam deactivation, nearly all the Y zeolite present in the catalyst amorphized. This amorphization is correlated with low pore volume, and these particles did not have minimum acceptable pore volume.

The coarse calcined flash calcined gibbsite was milled, using a Premier mill, monoclinic zirconia milling media, to d₉₀ of 4 μm and spray dried with 6% sodium silicate (3.22 modulus). As a result, the microsphere contained 91.4 wt. % alumina VF, 6.56 wt. % silica VF, and 2.18 wt. % Na₂O VF. The resultant particles had d₅₀ of about 95 μm, surface area of about 140 m²/g, and pore volume (as measured via Hg intrusion) of about 0.42 ml/g. The pore volume was about twice that of the parent FCA-90 particles; macropore volume of the spray dried particles was larger than total pore volume of the parent. These were crystallized using standard in situ FCC procedures with separate metakaolin particles, sodium silicate, caustic, seeds, and water at 88° C. Consistently, yields were about 200% of theoretical yield. The excessive Y zeolite yield would lead to Z/M ratios higher than intended. Surprisingly, crystallization proceeds well when the separate metakaolin particles are omitted. Crystallized material with useful Y zeolite content was successfully obtained using simply sodium silicate, caustic, seeds, and water at 88° C. It is believed that, prior to the present application, there has never been an in situ Y zeolite crystallization conducted without use of calcined kaolin clay. Catalysts were repeatedly made using this approach with usefully low Z/M. After ion exchange (ammonium nitrate and sufficient lanthanum nitrate to yield a 1 wt. % La₂O₃ material), calcination, additional ammonium nitrate exchange, and a second calcination, which is a typical in situ process to transform NaY zeolite into a fresh FCC catalyst, Z/M=0.9 (ZSA=94 m²/g, or equivalently, 14 wt. % Y zeolite) and total pore volume of 0.31 ml/g was achieved. After steaming (788° C., 100% steam, 24 hr), Z/M decreases to 0.55 and unit cell size is 24.351; zeolite surface area stability from NaY was an acceptable 38%. This catalyst was tested in a fixed fluid bed “ACE” reactor against an a control catalyst with Z/M=0.38 and steamed unit cell size of 24.348. The catalyst made without the use of calcined kaolin clay results in about 26% lower bottoms, 15% higher LCO/bottoms ratio, 24% higher propylene, about 18% higher C4 olefins, and comparable gasoline and comparable dry gas at constant coke relative to the control catalyst.

The Y zeolite in the steamed catalyst was characterized by X-ray diffraction using the Rietveld method. Rietveld analysis was performed using GSAS, described by A. C. Larson and R. B. Von Dreele, General Structure Analysis System (GSAS), Los Alamos National Laboratory Report LAUR 86-748 (2004). Assessment of Y zeolite properties is most interesting compared to a in situ clay reference catalyst. The clay reference catalyst was made following methods described in U.S. Pat. No. 6,656,347. SEM analysis shows a typical size for Y zeolite of about 2000 nm. In the NaY form, the crystallite size of Y zeolite was found, by Rietveld methods, to be about 1800 Å; strain is about 0.17%. Ion exchange and calcination procedures entail ultrastabilization, a process that Beyerlein and colleagues (see Topics in Catalysis, vol 4, 27-42, 1997 and Studies in Surface Science and Catalysis, vol 134, 3-40, 2001) showed results in breaking Y zeolite crystals and creation of new internal grain boundaries where mesopores and alumina films (formed from alumina originally in Y zeolite but liberated by dealumination) occur. Not surprisingly, crystallite size (size in coherently diffracting domains) decrease in this clay reference catalyst technology. Fresh catalyst of this comparative material, after ion exchange with ammonium and lanthanum cations, calcination, ion exchange with ammonium ion, and calcination, has Y zeolite isotropic size of about 690 Å, with strain of 0.62%. Steamed catalyst has Y zeolite isotropic size the same as fresh catalyst, about 665 Å and strain is 0.37%.

The catalyst made with no clay during crystallization, has much smaller crystallite size of about 467 Å at NaY, 368 Å after workup (ion exchange, calcination, ion exchange, and calcination) and 316 Å after steaming. Strain is not detectable at any stage, and the best estimate was zero strain. Crystallite size and strain were not previously thought to be related in zeolites. Without being bound by theory, strain is believed to be an assessment of defect density in zeolites. Perhaps variations in the number of framework aluminum atoms in unit cells across a crystallite, as well as other defects, can lead to strain. For relatively large crystallite size, defects can occur within the crystallite. But as crystallite size decreases, it becomes easier for these defects to collect and somehow coalesce at crystallite surfaces, that is, at grain boundaries and external surfaces. Thus, relatively small crystallites can help annihilate or decrease strain.

The catalyst described in this example produces much lower bottoms at constant coke, higher LCO/bottoms, and more LPG olefins than currently available catalysts. Without being bound by theory, it is believed that reasons for this include the very small crystallite size of Y zeolite in the experimental material and the very low level of strain. The alumina matrix and absence of high acidity clay matrix, lead to low coke selectivity that allow improved yields at constant coke. The low Z/M, unprecedented for alumina-matrix in situ FCC catalyst drives, desirably high LCO/bottoms. The unprecedented crystallization procedure that uses no calcined clay helps enable creation of this low-coke, high LCO/bottoms catalyst using affordable alumina matrix. Calcined flash calcined gibbsite is a particularly economical method of making active matrix for FCC cracking catalysis.

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

The present disclosure has been described with reference to specific exemplary embodiments thereof. The specification is, accordingly, to be regarded in an illustrative rather than a restrictive sense. Various modifications of the disclosure in addition to those shown and described herein will become apparent to those skilled in the art and are intended to fall within the scope of the appended claims.

1. A fluid catalytic cracking (FCC) catalyst component comprising:
an in-situ crystallized zeolite on pure alumina particles, wherein the FCC catalyst component has a ratio of zeolite surface area (ZSA) to matrix surface area (MSA) of less than about 1.3.

2. The FCC catalyst component of claim 1, wherein the pure alumina particles comprise one or more of alumina derived from boehmite, alumina derived from pseudo boehmite, alumina derived from flash calcined gibbsite, boehmite, pseudo boehmite, flash calcined gibbsite, calcined flash calcined gibbsite, silica-doped alumina, gamma-alumina, x-alumina, δ-alumina, θ-alumina, κ-alumina, α-alumina, rare earth-modified variations thereof, alkaline earth metal-modified variations thereof, bismuth-modified variations thereof, or a mixture of two or more thereof.

3. The FCC catalyst component of claim 1, wherein the pure alumina particles are unmilled.

4. The FCC catalyst component of claim 1, wherein the pure alumina particles have an average particle size of about 40 μm to about 150 μm, about 60 μm to about 120 μm, or about 80 μm to about 100 μm, and wherein the pure alumina particles are prepared by:
milling alumina precursors;
making a slurry from the alumina precursors; and
spray drying the slurried alumina precursors to arrive at pure alumina particles have the average particle size.

5. The FCC catalyst component of claim 1, wherein the zeolite is selected from zeolites with the structure BEA, MSE,-SVR, FAU, MOR, CON, SOF, MFI, IMF, FER, MWW, MTT, TON, EUO, MRE, NAT, CHA, EMT, or a mixture of two or more thereof.

6. The FCC catalyst component of claim 1, wherein the zeolite is selected from zeolite X, Y-zeolite, ZSM-5, beta zeolite, ZSM-11, ZSM-14, ZSM-17, ZSM-18, ZSM-20, ZSM-31, ZSM-34, ZSM-41, ZSM-46, mordenite, chabazite, or mixtures of two or more thereof.

7. The FCC catalyst component of claim 1, wherein the zeolite is Y-zeolite.

8. The FCC catalyst component of claim 7, wherein the Y-zeolite is present at less than about 20 wt. %.

9. The FCC catalyst component of claim 7, wherein the phase composition of the Y-zeolite ranges from about 5 wt. % to about 20 wt. %, based on total weight of the FCC catalyst component.

10. The FCC catalyst component of claim 6, wherein the zeolite has a unit cell size of about 24.50 Å to about 24.80 Å.

11. The FCC catalyst component of claim 6, wherein the zeolite has a unit cell size of about 24.40 Å or less.

12. The FCC catalyst component of claim 1, wherein the pure alumina particles have an average particle size of about 40 μm to about 150 μm.

13. The FCC catalyst component of claim 1, wherein the pure alumina particles are modified with a non-alumina constituent selected from a rare earth element, bismuth, an alkaline earth element, or a mixture of two or more thereof.

14. The FCC catalyst component of claim 1, wherein the pure alumina particles are modified with a rare earth element.

15. The FCC catalyst component of claim 14, wherein the rare earth element comprises ytterbium, gadolinium, cerium, lanthanum, or a mixture of two or more thereof.

16. The FCC catalyst component of claim 14, wherein the rare earth element comprises cerium.

17-24. (canceled)

25. A method for preparing a fluid catalytic cracking (FCC) catalyst component comprising:
crystallizing, in-situ, a zeolite on pure alumina particles, wherein the FCC catalyst component has a ratio of zeolite surface area (ZSA) to matrix surface area (MSA) of less than about 1.3.

26-50. (canceled)

51. A fluid catalytic cracking (FCC) catalyst composition comprising
a first FCC catalyst component being the FCC catalyst component according to claim 1; and
a second component that is compositionally different from the first FCC catalyst component.

52-56. (canceled)

57. A method of cracking a hydrocarbon feed comprising contacting said feed with a FCC catalyst component comprising:
an in-situ crystallized Y zeolite on pure alumina particles, wherein the FCC catalyst component has a ratio of zeolite surface area (ZSA) to matrix surface area (MSA) of less than about 1.3.

58-61. (canceled)

62. A method for preparing a fluid catalytic cracking (FCC) catalyst, the method comprising crystallizing, in-situ, a zeolite on alumina particles in the absence of clay.

63-68. (canceled)
